(19) United States
(12) Patent Application Publication
(10) Pub. No.: US 2025/0170705 A1
(43) Pub. Date: May 29, 2025

(54) ROBOT CONTROL WITH ERROR REDUCTION

(71) Applicant: KABUSHIKI KAISHA YASKAWA DENKI, Kitakyushu-shi (JP)

(72) Inventors: Arata TAKAKI, Fukuoka (JP); Takahiro KAMAKURA, Fukuoka (JP); Takefumi ASAHI, Fukuoka (JP); Yoshie MAEDA, Fukuoka (JP)

(21) Appl. No.: 18/959,623

(22) Filed: Nov. 26, 2024

(30) Foreign Application Priority Data
Nov. 28, 2023 (JP) 2023-201032

(51) Int. Cl. B25J 9/16

(52) U.S. Cl. CPC B25J 9/161; B25J 9/163; B25J 9/1653

(57) ABSTRACT

A robot system includes: a robot having an arm; and control circuitry configured to: store factor information representing an error factor of a motion of the robot, wherein the error factor is a mechanical characteristic of the robot that causes a positional error of an extremity of the arm and wherein the factor information has been predetermined based on a comparison between a programmed motion pattern and an actual motion of the robot that is operated according to the programmed motion pattern; calculate, based on a taught position of the robot and the factor information, a positional error of the extremity that would occur during an expected motion toward the taught position; and control, based on the taught position and the positional error, the robot to move the extremity toward the taught position with a positional adjustment of the robot to reduce the positional error.

### CROSS-REFERENCE TO RELATED APPLICATIONS

This application is based upon and claims the benefit of priority from Japanese Patent Application No. 2023-201032, filed on Nov. 28, 2023, the entire contents of which are incorporated herein by reference.

### BACKGROUND

### Field

The present disclosure relates to a robot system and a method for manufacturing a robot system.

### Description of the Related Art

Japanese Unexamined Patent Publication No. 2019-198925 discloses a control system including a controller and an operation device. The operation device acquires operation input from an operator, generates a command based on the operation input, and outputs it to the controller. The controller controls the robot according to the command from the operation device.

### SUMMARY

Disclosed herein is a robot system. The robot system may include: a robot having an arm configured to change a position of an extremity of the arm; and control circuitry configured to: store factor information representing an error factor of a motion of the robot, wherein the error factor is a mechanical characteristic of the robot that causes a positional error of the extremity and wherein the factor information has been predetermined based on a comparison between a programmed motion pattern and an actual motion of the robot that is operated according to the programmed motion pattern; calculate, based on a taught position of the robot and the factor information, a positional error of the extremity that would occur during an expected motion toward the taught position; and control, based on the taught position and the positional error, the robot to move the extremity toward the taught position with a positional adjustment of the robot to reduce the positional error.

Additionally, a method for manufacturing a robot system including a robot having an arm configured to change a position of an extremity of the arm and a control circuitry configured to control the robot is disclosed herein. The method may include: operating, by the control circuitry, the robot according to a predetermined motion pattern by the control circuitry; generating factor information representing an error factor based on the motion pattern and an actual motion of the robot according to the motion pattern, wherein the error factor is mechanical characteristic of the robot that causes a positional error of the extremity; and storing the factor information in the robot system.

### BRIEF DESCRIPTION OF THE DRAWINGS

FIG. 1 is a schematic diagram illustrating an example configuration of a robot system.

FIG. 2 is a block diagram illustrating an example functional configuration of a robot controller.

FIG. 3 is a schematic diagram illustrating an example correction of a positional command.

FIG. 4 is a block diagram illustrating an example functional configuration of a simulation device.

FIG. 5 is a block diagram illustrating an example hardware configuration of a control system.

FIG. 6 is a flowchart illustrating an example manufacturing procedure of a robot system.

FIG. 7 is a flowchart illustrating an example procedure for acquiring factor information.

FIG. 8 is a flowchart illustrating an example online teaching procedure.

FIG. 9 is a flowchart illustrating an example robot control procedure.

FIG. 10 is a flowchart illustrating an example procedure for acquiring surrounding information.

FIG. 11 is a flowchart illustrating an example procedure for reproducing operation.

FIG. 12 is a flowchart illustrating an example offline teaching procedure.

### DETAILED DESCRIPTION

In the following description, with reference to the drawings, the same reference numbers are assigned to the same components or to similar components having the same function, and overlapping description is omitted.

### Robot System

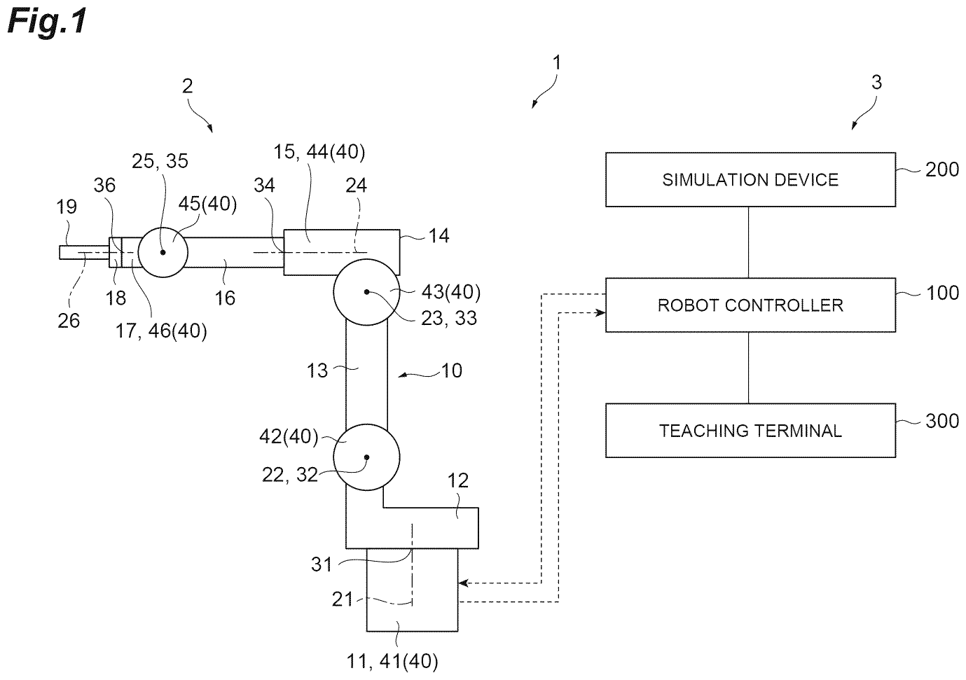

As illustrated in FIG. 1, a robot system 1 is a system for causing a robot 2 to execute tasks. Examples of tasks include tasks on workpieces such as transporting workpieces, processing workpieces, and assembling workpieces. Examples of processing workpieces include grinding and polishing of workpieces. Examples of assembling workpieces include fastening multiple parts (parts of workpieces) together with bolts and joining multiple parts together by welding.

The robot system 1 includes the robot 2 and a control system 3. The robot 2 is, for example, an industrial vertical articulated robot having an arm 10 capable of changing the position of an extremity of the arm 10 (for example, a hand tip). The hand tip is, for example, the distal end portion of an end effector 19 that acts on a workpiece. The arm 10 may be capable of changing the position and posture of the hand tip.

The control system 3 includes a robot controller 100 for controlling the robot 2. The robot controller 100 operates the robot 2 according to one or more taught positions. Each of the one or more taught positions represents the motion of the robot 2. For example, each of the one or more taught positions includes information specifying the target position and target posture of the hand tip. The taught position may include information directly specifying the target position and target posture of the hand tip, or information indirectly specifying the target position and target posture of the hand tip. Examples of information indirectly specifying the target position and target posture of the hand tip include information on the target angles of each joint of the arm 10.

The one or more taught positions may be a plurality of taught positions included in a pre-generated and stored motion program (motion path) in a time series. The one or more taught positions may be taught positions of the robot system 1 temporarily generated based on manual operation by a user.

The control system 3 may further include a simulation device 200 and a teaching terminal 300. The simulation device 200 and the teaching terminal 300 can communicate with the robot controller 100. The teaching terminal 300 is, for example, a programming pendant that accepts manual operation by a user for motion teaching of the robot 2 or the like.

Motion teaching means, for example, the task of storing the operation to be executed by the robot 2 as a motion program. Motion teaching includes offline teaching performed by the simulation device 200 without operating the robot 2 and online teaching performed by operating the robot 2 based on input to the teaching terminal 300. Motion teaching also includes correcting a motion program generated by offline teaching through online teaching.

For example, the arm 10 includes a base 11, a rotational portion 12, a first arm 13, a second arm 14, a third arm 17, a distal end portion 18, and one or more motors 40. The base 11 is installed on a floor of a work area, for example. The base 11 may be installed on a moving body such as an automated guided vehicle that moves within the work area.

The rotational portion 12 is provided on the base 11 to rotate about a vertical axis 21. The first arm 13 is connected to the base 11 to swing about an axis 22 intersecting (for example, orthogonal to) the axis 21 and extends in a direction away from the axis 22. The intersection includes a skewed relationship, such as a three-dimensional intersection. The same applies hereinafter.

The second arm 14 is connected to the end of the rotational portion 12 to swing about an axis 23 parallel to the axis 22. The second arm 14 includes an arm base portion 15 and an arm end 16. The arm base portion 15 extends in a direction away from the axis 23. The second arm 14 is connected to the end of the arm base portion 15 to rotate about an axis 24 along the center axis of the arm base portion 15 and extends further along the axis 24 from the arm base portion 15.

The third arm 17 is connected to the end of the arm end 16 to swing about an axis 25 intersecting (for example, orthogonal to) the axis 24 and extends in a direction away from the axis 25. The distal end portion 18 is connected to the third arm 17 to rotate about an axis 26 along the center axis of the third arm 17.

Thus, the arm 10 includes a joint 31 that allows the rotational portion 12 to rotate about the axis 21 relative to the base 11, a joint 32 that allows the first arm 13 to swing about the axis 22 relative to the rotational portion 12, a joint 33 that allows the arm base portion 15 to swing about the axis 23 relative to the first arm 13, a joint 34 that allows the arm end 16 to rotate about the axis 24 relative to the arm base portion 15, a joint 35 that allows the third arm 17 to swing about the axis 25 relative to the arm end 16, and a joint 36 that allows the distal end portion 18 to rotate about the axis 26 relative to the third arm 17.

The end effector 19 described above is attached to the distal end portion 18. Examples of the end effector 19 include a suction nozzle for holding a workpiece, a hand for gripping a workpiece, a grinding tool for grinding a workpiece, a polishing tool for polishing a workpiece, a screw tightening tool (for example, a driver or wrench) for tightening screws (for example, bolts), a welding gun for spot welding, a welding torch for arc welding, and a painting gun for painting, but are not limited to these examples. The arm 10 changes the position and posture of the distal end portion 18 by the operation of the joints 31, 32, 33, 34, 35, and 36, thereby changing the position and posture of the hand tip, which is the distal end portion of the end effector 19.

One or more motors 40 move the arm 10. For example, the arm 10 includes a plurality of motors 41, 42, 43, 44, 45, and 46 as the one or more motors 40. The motors 41, 42, 43, 44, 45, and 46 respectively operate the six-axis joints 31, 32, 33, 34, 35, and 36 to change the position and posture of the distal end portion 18. This changes the position and posture of the distal end portion 18 and the position and posture of the control system 3.

For example, the motor 41 drives the joint 31 to rotate the rotational portion 12 about the axis 21. The motor 42 drives the joint 32 to swing the first arm 13 about the axis 22. The motor 43 drives the joint 33 to swing the arm base portion 15 about the axis 23. The motor 44 drives the joint 34 to rotate the arm end 16 about the axis 24. The motor 45 drives the joint 35 to swing the third arm 17 about the axis 25. The motor 46 drives the joint 36 to rotate the distal end portion 18 about the axis 26.

Each of the motors 41, 42, 43, 44, 45, and 46 is, for example, an electric motor. Each of the motors 41, 42, 43, 44, 45, and 46 may directly drive the target to be driven or may drive it through a transmission element such as a reducer.

The example configuration of the arm 10 described above is merely an example and can be modified as long as the position and posture of the control system 3 can be changed. For example, the arm 10 may be a redundant robot with one or more redundant axes added to the six-axis joints described above. The arm 10 may be a SCARA robot or a parallel link robot.

The robot 2 configured as described above includes an error factor of motion caused by the structure of the arm 10. The error factor is a mechanical characteristic of the robot that causes a positional error of the hand tip. Therefore, if the robot 2 is operated by a taught position generated without considering the error factor, the position and posture of the hand tip may deviate from the taught position. Hereinafter, such deviation is referred to as a motion error. If the motion error is not acceptable, the robot 2 cannot be operated by a taught position generated without considering the error factor, and the robot 2 including the error factor may be actually operated to regenerate the taught position. Moreover, since there are individual differences in the error factors of the robot 2, each of the plurality of robots 2 may be actually operated to regenerate the taught position.

Accordingly, the robot controller 100 is configured to execute: storing factor information representing an error factor of motion caused by the structure of the arm 10; and controlling the robot 2 so that a motion error caused by the error factor is reduced based on a taught position representing the motion of the robot 2 and the factor information.

According to the robot controller 100, the motion error caused by the error factor is reduced when control is executed based on the taught position without including the error factor in the taught position. Therefore, even if the taught position is generated without considering the error factor, control that reduces the motion error with respect to the taught position is executed. Accordingly, the robot controller 100 is beneficial in improving the workability of motion teaching. According to the robot controller 100, the robot 2 can be controlled with accuracy in the real space even by the taught position generated by offline teaching in a virtual space without an error factor. Moreover, the teaching result can be applied to a plurality of robots 2 with individual differences.

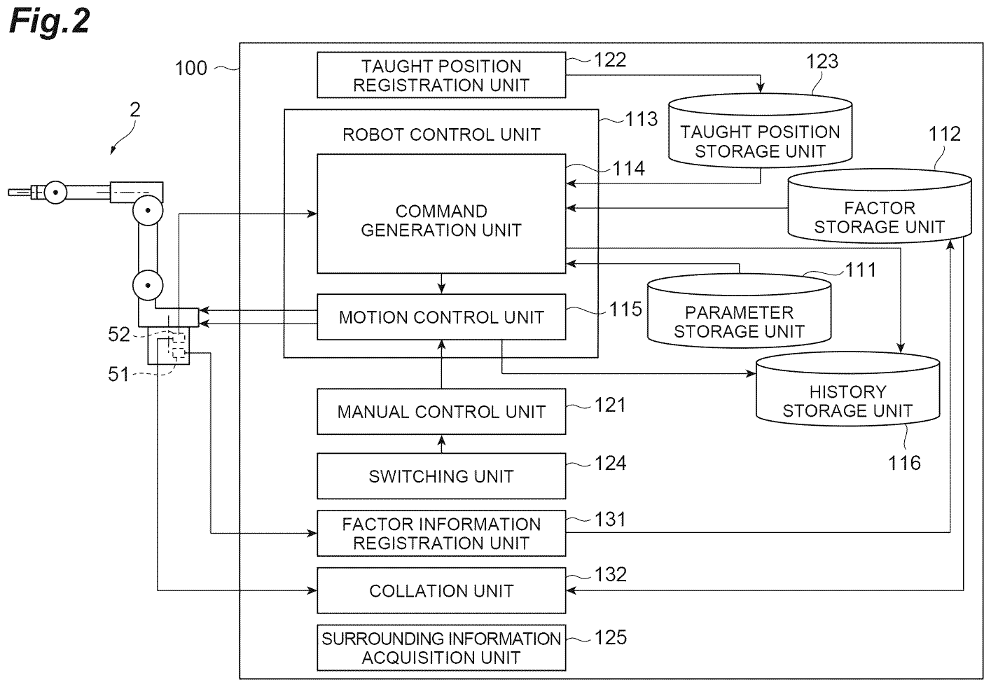

For example, as illustrated in FIG. 2, the robot controller 100 includes functional components (hereinafter referred to as “functional blocks”) such as a parameter storage unit 111, a factor storage unit 112, and a robot control unit 113. The parameter storage unit 111 includes kinematic parameters of the robot 2. The kinematic parameters are, for example, DH parameters and include link lengths and joint positions. The link lengths include, for example, the lengths of a plurality of links (for example, the base 11, the rotational portion 12, the first arm 13, the arm base portion 15, the arm end 16, the third arm 17, and the distal end portion 18) connected by a plurality of joints (for example, the joints 31, 32, 33, 34, 35, and 36). The joint positions include the connection order of the plurality of joints and the plurality of links. The parameter storage unit 111 may further include mechanical parameters of the robot 2. The mechanical parameters further include weight information of each part of the robot 2.

The factor storage unit 112 stores factor information representing an error factor. The error factor may include the compliance of the arm 10. The compliance represents the flexibility (or rigidity) of the arm 10. The error factor may include a dimensional error of the arm 10. Examples of dimensional errors include errors in link lengths, positional deviations between links, and angular errors at the origin positions.

The factor information may include the compliance of the joints 31, 32, 33, 34, 35, and 36 as information representing the compliance of the arm 10. The compliance of the joint 31 represents, for example, the flexibility (ease of displacement due to deflection) of the end of the rotational portion 12 (for example, the joint 32) relative to the joint 31. The compliance of the joint 32 represents, for example, the flexibility of the end of the first arm 13 (for example, the joint 33) relative to the joint 32. The compliance of the joint 33 represents, for example, the flexibility of the end of the second arm 14 (for example, the joint 35) relative to the joint 33. The compliance of the joint 34 represents, for example, the flexibility of the end of the arm end 16 (for example, the joint 35) relative to the joint 34. The compliance of the joint 35 represents, for example, the flexibility of the end of the third arm 17 (for example, the joint 36) relative to the joint 35. The compliance of the joint 36 represents, for example, the flexibility of the end of the end effector 19 relative to the joint 36.

The factor information may include information representing the dimensional error of the arm 10, such as errors in the lengths of the base 11, the rotational portion 12, the first arm 13, the arm base portion 15, the arm end 16, the third arm 17, the distal end portion 18, and the end effector 19. Furthermore, the factor information may include a positional deviation of the rotational portion 12 relative to the base 11, a positional deviation of the first arm 13 relative to the rotational portion 12, a positional deviation of the arm base portion 15 relative to the first arm 13, a positional deviation of the arm end 16 relative to the arm base portion 15, a positional deviation of the third arm 17 relative to the arm end 16, a positional deviation of the distal end portion 18 relative to the third arm 17, and a positional deviation of the end effector 19 relative to the distal end portion 18.

The motion error caused by the error factor is, for example, a difference between the target position and target posture of the hand tip (the distal end portion of the end effector 19) and the actual position and posture of the hand tip due to the accumulation of error factors.

The robot control unit 113 controls the robot 2 so that the motion error is reduced based on the taught position representing the operation of the robot 2 and the factor information. For example, the robot control unit 113 calculates, based on the taught position and the factor information, a positional error of the hand tip that would occur during an expected motion toward the taught position. The robot control unit controls, based on the taught position and the first positional error, the robot 2 to move the hand tip toward the taught position with a positional adjustment to reduce the positional error. For example, the robot control unit 113 generates a positional command by adding a component to cancel the motion error to the taught position and controls the robot 2 to follow the positional command. A target position of the positional command may be the taught position.

For example, the robot control unit 113 includes a command generation unit 114 and a motion control unit 115. The command generation unit 114 sequentially generates positional commands representing intermediate positions of the robot 2 to the taught position based on the taught position and the factor information. A target position of the last positional command may be the taught position.

The positional command represents the intermediate position and intermediate posture of the hand tip. The positional command may directly represent the intermediate position and intermediate posture of the hand tip, or may indirectly represent the intermediate position and intermediate posture of the hand tip. For example, the positional command may indirectly represent the intermediate position and intermediate posture of the hand tip by the angles of the joints 31, 32, 33, 34, 35, and 36.

The positional command representing the intermediate positions of the robot 2 to the taught position is sequentially generated so that the motion error is reduced based on the taught position and the factor information. The intermediate positions include the positions passed through before reaching the taught position and the taught position itself. The motion control unit 115 controls the robot 2 by the sequentially generated positional commands. For example, the command generation unit 114 and the motion control unit 115 repeat the generation of the positional command and the control of the robot 2 by the positional command at a predetermined control cycle (for example, 10 ms or less). The motion error can be reduced even in the intermediate path to the taught position.

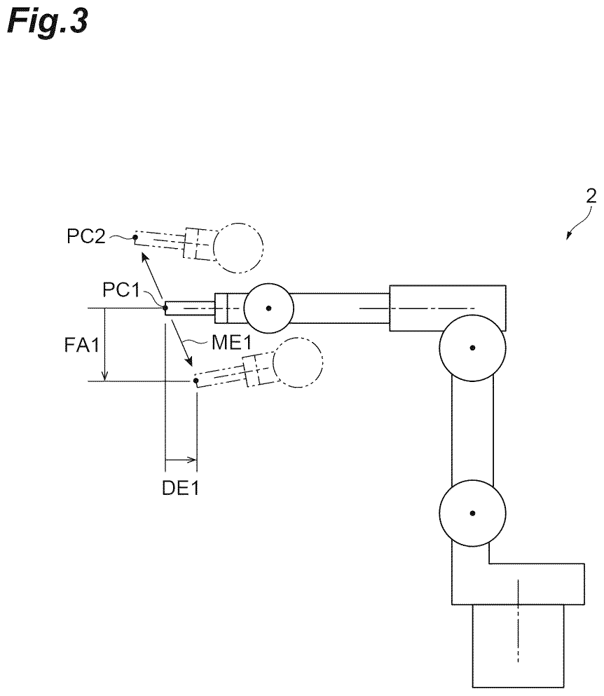

Referring to FIG. 3, an example generation of the positional command by the command generation unit 114 is illustrated. In each cycle repeated at the control cycle, the command generation unit 114 generates a provisional positional command based on the taught position. For example, the command generation unit 114 generates a provisional positional command PC1 including a cycle target position and a cycle target posture of the hand tip based on the current position and current posture of the hand tip, the target position and target posture of the hand tip specified by the taught position, and a predetermined interpolation method. The interpolation method may be stored in association with the taught position. The cycle target position and cycle target posture are the target position and target posture of the hand tip at the end of the cycle.

The command generation unit 114 calculates, based on the provisional positional command and the factor information, a positional error (first positional error) of the had tip that would occur during an expected motion of the robot 2 toward the taught position. For example, the command generation unit 114 calculates, as the positional error, the deflection FA1 of the arm 10 based on the provisional positional command PC1, the compliance of the arm 10 included in the factor information, and the kinematic parameters and mechanical parameters of the robot 2 stored in the parameter storage unit 111. For example, the command generation unit 114 calculates the moments acting on the joints 31, 32, 33, 34, 35, and 36 based on the provisional positional command PC1 and the kinematic parameters and mechanical parameters, and calculates the deflection occurring in each of the joints 31, 32, 33, 34, 35, and 36 based on the calculated moments and the compliance of each of the joints 31, 32, 33, 34, 35, and 36. Furthermore, the command generation unit 114 calculates, based on the deflection occurring in each of the joints 31, 32, 33, 34, 35, and 36 and the kinematic parameters, the deflection FA1 that is the displacement vector of the hand tip due to the deflection as the motion error ME1.

The command generation unit 114 generates a positional command PC2 based on the motion error ME1 and the provisional positional command PC1. For example, the command generation unit 114 generates the positional command PC2 so that the motion error ME1 is reduced. For example, the command generation unit 114 generates the positional command PC2 by adding a vector of the same magnitude as the motion error ME1 but in the opposite direction as the motion error ME1 to the provisional positional command PC1 so as to cancel the deflection FA1. The motion error due to the deflection can be reduced with accuracy.

The command generation unit 114 may generate the positional command PC2 based on the provisional positional command PC1, the dimensional error DE1, and the deflection FA1. For example, the command generation unit 114 calculates the displacement vector of the hand tip due to the dimensional error as the dimensional error DE1 based on the kinematic parameters and the dimensional error. The displacement vector here is a vector from the hand tip in the absence of the dimensional error to the hand tip in the presence of the dimensional error. The command generation unit 114 generates the positional command PC2 by adding a vector of the same magnitude as the motion error ME1 but in the opposite direction as the motion error ME1 to the provisional positional command PC1 so as to reduce the motion error ME1, which is a combination of the deflection FA1 and the dimensional error DE1. For example, the command generation unit 114 generates the positional command PC2 by adding a vector in the opposite direction to the motion error ME1, which is a combination of the deflection FA1 and the dimensional error DE1, to the provisional positional command PC1 so as to cancel the motion error ME1.

The command generation unit 114 may reflect the dimensional error in the deflection FA1. For example, the command generation unit 114 may calculate the deflection FA1 further based on the dimensional error in addition to the provisional positional command PC1, the kinematic parameters and mechanical parameters. By reflecting the dimensional error in the deflection FA1, the deflection FA1 can be calculated with higher accuracy. When reflecting the dimensional error in the deflection FA1, in actual calculations, the deflection FA1 and the dimensional error DE1 may not be calculated separately as illustrated. For example, the motion error ME1 may be calculated without going through the calculation of the deflection FA1 and the dimensional error DE1 by accumulating the deflection and the dimensional error for each link.

The dimensional error may be reflected in the kinematic parameters in advance. The parameter storage unit 111 constitutes a part of the factor storage unit 112.

Returning to FIG. 2, the motion control unit 115 calculates the target angles of the joints 31, 32, 33, 34, 35, and 36 corresponding to the positional command (the positional command generated by the command generation unit 114) by inverse kinematic calculation based on the kinematic parameters, and controls the motors 41, 42, 43, 44, 45, and 46 to follow the target angles of the joints 31, 32, 33, 34, 35, and 36.

The robot controller 100 may further include a history storage unit 116. The history storage unit 116 stores the motion history of the robot 2 in association with at least one of the positional command and the provisional positional command. By comparing the motion history with the positional command or the provisional positional command, the presence of external factors such as collisions can be readily verified afterward. For example, the history storage unit 116 sequentially stores motion records including the motion results (motion angles) of the joints 31, 32, 33, 34, 35, and 36 corresponding to the positional command in association with the time and at least one of the positional command and the provisional positional command for each control cycle. As a result, the motion history represented by a plurality of motion records arranged in a time series is stored in the history storage unit 116. The history storage unit 116 may store the positional command without storing the provisional positional command, may store the provisional positional command without storing the positional command, or may store both the positional command and the provisional positional command.

The robot controller 100 may further include a manual control unit 121, a taught position registration unit 122, and a taught position storage unit 123. The manual control unit 121 generates a taught position (manually taught position) based on manual operation by a user and controls the robot 2 so that the motion error is reduced based on the generated taught position and the factor information. For example, the manual control unit 121 calculates, based on the manually taught position and the factor information, a positional error (a second positional error) of the hand tip that would occur during an expected motion toward the manually taught position. The manual control unit 121 controls, based on the manually taught position and the second positional error, the robot to move the hand tip toward the manually taught position with the positional adjustment to reduce the second positional error. For example, the manual control unit 121 may generate a taught position based on manual operation on the teaching terminal 300. Examples of manual operations include jog operations for commanding movement by one pitch in the specified direction and position specifying operations for specifying the desired position.

For example, the manual control unit 121 generates a taught position based on manual operation and sequentially generates positional commands representing intermediate positions of the robot 2 to the taught position so that the motion error is reduced based on the generated taught position and the factor information. For example, the manual control unit 121 generates positional commands in the same manner as the command generation unit 114 and causes the motion control unit 115 to control the robot 2 based on the generated positional commands. Since the manual control unit 121 generates positional commands in the same manner as the command generation unit 114, a state in which the motion error of the robot 2 with respect to the taught position is reduced is maintained.

When the motion of the robot 2 to the taught position is completed, the manual control unit 121 stops the robot 2 and waits for the next manual operation. Even while waiting for the next manual operation, the manual control unit 121 continues to control the robot 2. For example, the manual control unit 121 repeatedly causes the motion control unit 115 to control the robot 2 based on the same positional command at the control cycle. As a result, the robot 2 is maintained at the taught position.

In a state where the robot 2 is maintained at the taught position, the taught position registration unit 122 stores the taught position in the taught position storage unit 123 when a registration operation is performed by the user. For example, the taught position registration unit 122 stores the taught position in the taught position storage unit 123 when a registration operation is performed on the teaching terminal 300. The taught position storage unit 123 stores a plurality of taught positions registered by a plurality of registration operations in a time series.

The taught position can be registered by visually confirming that the motion error is reduced based on the factor information relative to the taught position based on the manual operation. Since the taught position is registered with the value before reflecting the error factor, the error factor can be excluded from the taught position. Accordingly, the taught position without considering the error factor can be readily registered in the actual machine with the error factor.

The robot control unit 113 controls the robot 2 based on the taught position stored in the taught position storage unit 123 and the factor information so that the motion error is reduced. For example, the robot control unit 113 sequentially reads the taught positions stored in the taught position storage unit 123 and controls the robot 2 based on the read taught positions and the factor information so that the motion error is reduced. For example, the robot control unit 113 sequentially executes the operation of the robot 2 to the taught position by repeating the generation of the positional command by the command generation unit 114 and the control of the robot 2 by the motion control unit 115 for the read taught positions. As a result, the operation represented by a plurality of taught positions stored in the taught position storage unit 123 is played back by the robot 2.

The robot controller 100 may further include a switching unit 124. The switching unit 124 switches whether the reflection of the factor information (error reduction) by the manual control unit 121 is enabled based on a switching operation performed by the user on the teaching terminal 300. The manual control unit 121 controls the robot 2 based on the taught position based on the manual operation and the factor information when the reflection of the factor information is enabled, and controls the robot 2 not based on the factor information but based on the taught position based on the manual operation when the reflection of the factor information is disabled. For example, the manual control unit 121 controls, based on the manually taught position and the second positional error, the robot 2 to move the hand tip toward the manually taught position with the positional adjustment in response to determining that the error reduction is enabled. The manual control unit 121 controls, based on the manually taught position, the robot 2 to move the hand tip toward the manually taught position without the positional adjustment in response to determining that the error reduction is disabled.

For example, when the reflection of the factor information is enabled, the manual control unit 121 generates positional commands in the same manner as the command generation unit 114. When the reflection of the factor information is disabled, the manual control unit 121 generates a provisional positional command in the same manner as the command generation unit 114 and uses the provisional positional command as the positional command without reflecting the motion error.

The taught position registration unit 122 stores reflection information (setting information) indicating whether the factor information is reflected in the taught position storage unit 123 in association with the taught position based on the manual operation. For example, when storing the reflection information in the taught position storage unit 123 in response to a registration operation on the teaching terminal 300, the taught position registration unit 122 stores the reflection information in the taught position storage unit 123 in association with the taught position. The taught position storage unit 123 stores the taught position and the reflection information in association.

The robot control unit 113 controls the robot 2 based on the taught position and the factor information when the reflection information corresponding to the taught position indicates that reflection of the factor information is enabled. For example, the robot control unit 113 controls, based on both the stored taught position and the first positional error, the robot 2 to move the hand tip toward the stored taught position with the positional adjustment in response to determining that the setting information corresponding to the stored taught position indicates that the error reduction is enabled. The robot control unit 113 controls, based on the stored taught position, the robot 2 to move the hand tip toward the stored taught position without the positional adjustment in response to determining that the setting information corresponding to the stored taught position indicates that the error reduction is disabled. For example, the command generation unit 114 generates a positional command based on the provisional positional command and the factor information so that the motion error is reduced as described above. When the reflection information indicates that reflection of the factor information is disabled, the robot control unit 113 controls the robot 2 not based on the factor information but based on the taught position. For example, the command generation unit 114 uses the provisional positional command as the positional command without reflecting the motion error after generating the provisional positional command. By matching the presence or absence of the reduction of the motion error at the time of registering the taught position and at the time of playing back the registered taught position, unexpected operation of the robot can be prevented.

The robot control unit 113 may control the robot 2 not based on the factor information but based on the taught position when the reflection information is not associated with the taught position stored in the taught position storage unit 123. For example, the robot control unit 113 controls, based on the stored taught position, the robot 2 to move the hand tip toward the stored taught position without the positional adjustment in response to determining that the setting information is not associated with the taught position stored in the taught position storage unit 123. Accordingly, unexpected operation of the robot 2 due to the application of the motion error reduction function to a taught position that does not assume the motion error reduction function may be prevented. For example, in an existed robot system before the configuration according to the present disclosure is applied, the reflection information is not associated with the taught position. An example of a case where the reflection information is not associated with the taught position is when the taught position stored in the existed robot system is reused.

The robot controller 100 may further include a surrounding information acquisition unit 125. The surrounding information acquisition unit 125 acquires positional information of a surrounding object based on the relative position of the hand tip with respect to the surrounding object and the taught position at which the hand tip reaches the relative position. For example, the surrounding information acquisition unit 125 acquires positional information of the surrounding object based on the known relative position and the taught position that caused the hand tip to reach the relative position when the user notifies that the hand tip is placed at a known relative position with respect to the surrounding object. The known relative position with respect to the surrounding object may be a predetermined position on the surface of the surrounding object.

For example, in a state where the manual control unit 121 causes the hand tip of the robot 2 to stop at the above-described predetermined position in response to the manual operation, the surrounding information acquisition unit 125 acquires positional information of the surrounding object in a robot coordinate system with the base 11 as the reference based on the relative position of the surrounding object with respect to the predetermined position and the taught position generated immediately before by the manual control unit 121. The surrounding information acquisition unit 125 may further acquire positional information including the posture of the surrounding object based on the positional information of a plurality of predetermined positions whose relative positions to the surrounding object are known. For example, the surrounding information acquisition unit 125 may acquire the relationship between the surrounding coordinate system based on the surrounding object and the robot coordinate system.

Due to the reduction of the motion error, the difference between the position of the hand tip and the taught position is minimized. Therefore, the positional information of the surrounding object can be readily acquired with high accuracy based on the taught position.

The relative position of the hand tip with respect to the surrounding object may not be limited to a known relative position and may be, for example, a relative position detected by a camera or a laser sensor mounted on the distal end portion 18. The positional information of the surrounding object can be acquired by placing the hand tip so that the surrounding object enters the detection range of the camera or laser sensor without placing the hand tip at a known relative position.

The configuration of the robot controller 100 illustrated above is an example and can be modified. For example, the factor storage unit 112 may store a plurality of pieces of factor information corresponding to a plurality of robots 2. The robot control unit 113 may select one of the plurality of pieces of factor information according to the robot 2 to be controlled and control the robot 2 based on the selected factor information.

For example, the factor storage unit 112 may store a plurality of pieces of factor information and the corresponding IDs of the robots 2 in association with each other. The command generation unit 114 may acquire the ID of the robot 2, select the factor information corresponding to the acquired ID from the plurality of pieces of factor information, and generate the positional command based on the selected factor information. For example, the robot 2 may further include an ID storage unit 52 for storing the ID, and the command generation unit 114 may acquire the ID of the robot 2 from the ID storage unit 52. The ID storage unit 52 is, for example, implemented on a circuit board or the like built into the robot 2. The ID of the robot 2 may be any information that can identify the robot 2. For example, the MAC address of the circuit board or the MAC address of a sensor included in the robot 2 can be used as the ID of the robot 2.

The robot control unit 113 may control the robot 2 based on the factor information when the factor information corresponding to the ID of the robot 2 is included in the plurality of pieces of factor information, and may display an error on the teaching terminal 300 or the like without controlling the robot 2 when the factor information corresponding to the ID of the robot 2 is not included in the plurality of pieces of factor information (when the command generation unit 114 cannot select the factor information).

When storing a single piece of factor information, the factor storage unit 112 may store the factor information in association with the ID of the robot 2. The robot control unit 113 may control the robot 2 based on the factor information when the ID of the robot 2 to be controlled matches the ID corresponding to the factor information, and may display an error on the teaching terminal 300 or the like without controlling the robot 2 when the ID of the robot 2 does not match the ID corresponding to the factor information.

The factor information may be stored in the robot 2. For example, the robot 2 may further include a factor information storage unit 51. The factor information storage unit 51 stores the factor information of the robot 2. The factor information storage unit 51 is built into the robot 2 and implemented on the above-mentioned circuit board or the like.

The robot controller 100 may further include a factor information registration unit 131. The factor information registration unit 131 acquires the factor information from the factor information storage unit 51 of the robot 2 and stores it in the factor storage unit 112. The factor information registration unit 131 may acquire the factor information from the factor information storage unit 51 of the robot 2, acquire the ID of the robot 2 from the ID storage unit 52 of the robot 2, and store the factor information in association with the ID in the factor storage unit 112. By acquiring the factor information from the robot 2, the mismatch between the factor information and the robot 2 can be readily prevented.

The robot controller 100 may further include a collation unit 132. The collation unit 132 collates the factor information stored in the robot 2 with the factor information stored in the factor storage unit 112. The mismatch between the factor information and the robot can be further prevented.

Collation refers to checking whether they match by comparing them. For example, the collation unit 132 acquires the ID of the robot 2 from the ID storage unit 52 and determines that the factor information stored in the robot 2 (the factor information storage unit 51) matches the factor information stored in the factor storage unit 112 when the acquired ID matches the ID associated with the factor information in the factor storage unit 112. Conversely, the collation unit 132 determines that the factor information stored in the robot 2 does not match the factor information stored in the factor storage unit 112 when the ID acquired from the ID storage unit 52 does not match the ID associated with the factor information in the factor storage unit 112.

As described above, the simulation device 200 executes the simulation of the operation of the robot 2. The simulation of the operation of the robot 2 refers to calculating simulation data such as the transition of the posture of the robot 2 and the transition of the positional relationship between the robot 2 and surrounding objects when the robot 2 is operated, without actually operating the robot 2. Calculating the simulation data corresponds to operating the robot 2 in a virtual space.

The simulation of the operation of the robot 2 includes reproducing, in the virtual space, the operation of the robot 2 in the real space based on the motion history stored in the history storage unit 116. As described above, the motion history stored in the history storage unit 116 includes the actual motion results (motion angles) of the joints 31, 32, 33, 34, 35, and 36. These motion results correspond to the positional commands in which the factor information is reflected (for example, a vector in the opposite direction to the motion error is added).

In the real space including the error factor, the motion error is canceled by reflecting the factor information, and the hand tip is placed at the position corresponding to the taught position (for example, the provisional positional command PC1). In contrast, in the virtual space not including the error factor, the hand tip is placed at a position where a vector in the opposite direction to the motion error is added to the position corresponding to the taught position (for example, the position corresponding to the positional command PC2) by reflecting the factor information. Therefore, there is a difference between the operation of the robot 2 in the virtual space and the operation of the robot 2 in the real space. Not including the error factor means that the deflection due to compliance and the positional deviation due to the dimensional error are not calculated in the simulation.

On the other hand, if the error factor is also included in the simulation, the simulation for each of the plurality of robots 2 with different error factors may individually be reconstructed, and in addition, the calculation amount becomes enormous, making it very difficult to reproduce the actual operation.

Therefore, the simulation device 200 may be configured to convert the motion history of the robot 2 into the motion history when the motion error is not reduced, and reproduce the operation of the robot 2 in the virtual space based on the model of the robot 2 without the error factor and the converted motion history. The operation of the robot in the real space including the error factor can be readily reproduced in the virtual space not including the error factor.

Assuming that the reality includes the error factor and the simulation does not include the error factor, the error factor is corrected when operating the robot 2, and the error factor is restored when reproducing in the simulation. Accordingly, the way the error factor is reflected is intuitively understandable for the user, and the system construction and operation can be facilitated.

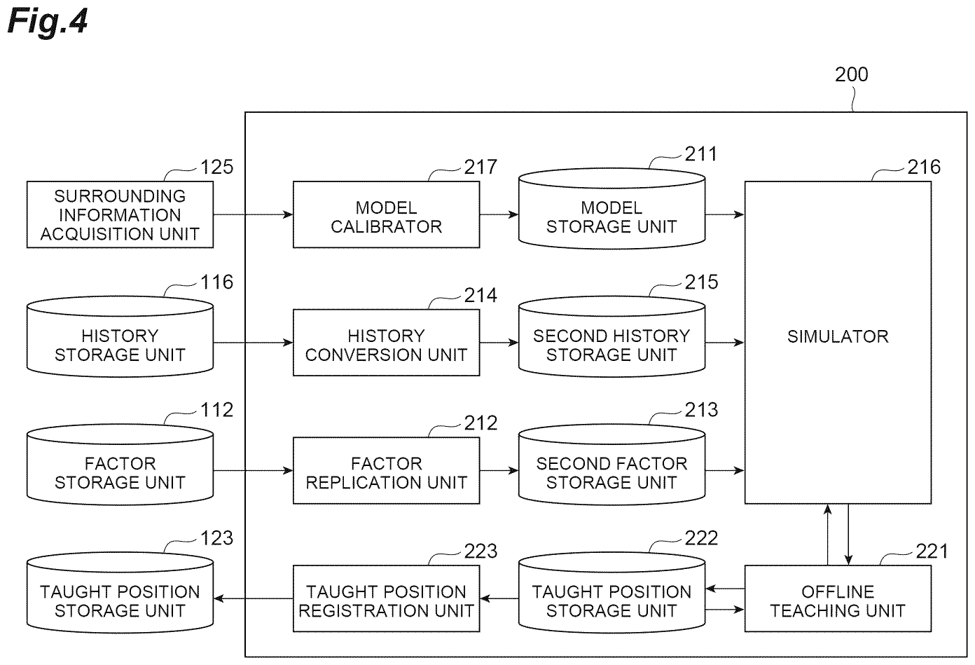

For example, as illustrated in FIG. 4, the simulation device 200 includes, as functional blocks, a model storage unit 211, a factor replication unit 212, a second factor storage unit 213, a history conversion unit 214, a second history storage unit 215, and a simulator 216. The model storage unit 211 stores models of the robot 2 and surrounding objects. The model is numerical data representing the shape, structure, dimensions, and the like. The model of the robot 2 includes information on the surface shape of each link in addition to the kinematic parameters described above.

The factor replication unit 212 acquires the factor information from the factor storage unit 112 of the robot 2 and stores it in the second factor storage unit 213 outside the robot 2. By storing the factor information in the second factor storage unit 213 separate from the factor storage unit 112, the conversion of the motion history and the reproduction of the operation of the robot 2 in the virtual space can be executed even when the robot controller 100 is not activated. The simulation device 200 may be configured to collate the factor information stored in the second factor storage unit 213 with the factor information stored in the factor storage unit 112 and display an error when the factor information stored in the second factor storage unit 213 does not match the factor information stored in the factor storage unit 112.

The history conversion unit 214 converts the motion history stored in the history storage unit 116 into the motion history when the motion error is not reduced based on the factor information stored in the second factor storage unit 213 and stores it in the second history storage unit 215. For example, the history conversion unit 214 converts the motion history of the robot 2 by removing, based on the factor information, a history of the error adjustment from the motion history. For example, the history conversion unit 214 calculates the motion error in the same manner as the command generation unit 114 based on the motion history and the kinematic parameters and mechanical parameters. The history conversion unit 214 corrects the motion angles of the joints 31, 32, 33, 34, 35, and 36 in the motion records so as to displace the hand tip corresponding to the motion error based on the kinematic parameters and the motion error.

The simulator 216 reproduces, in the virtual space, the operation of the robot 2 based on the model of the robot 2 without the error factor and the converted motion history (the motion history stored in the second history storage unit 215). For example, the simulator 216 reproduces, in the virtual space, the operation of the robot 2 by forward kinematic calculation based on the angles of the joints 31, 32, 33, 34, 35, and 36 included in the converted motion history and the model of the robot 2 stored in the model storage unit 211.

The simulation device 200 may further include a model calibrator 217. The model calibrator 217 corrects the position of the model of the surrounding object in the virtual space based on the positional information of the surrounding object acquired by the surrounding information acquisition unit 125 as described above. For example, the model calibrator 217 acquires the relationship between the surrounding coordinate system described above and the robot coordinate system from the surrounding information acquisition unit 125 and corrects the position and posture of the model of the surrounding object in the virtual space so as to match the acquired relationship. The virtual space in which the positional information of the surrounding object acquired with accuracy is reflected in the model allows the relationship between the operation of the robot 2 and the surrounding object to be simulated with accuracy. Based on the positional information of the surrounding object acquired in the real space with reduced motion error with respect to the taught position and the motion history matched to the virtual space not including the error factor, a reliable simulation can be readily executed.

The simulation device 200 may further include an offline teaching unit 221. The offline teaching unit 221 generates a taught position based on the operation of the robot 2 in the virtual space and stores it in the taught position storage unit 222. For example, the offline teaching unit 221 generates a taught position based on manual operation by a user and operates the robot 2 in the virtual space to place the hand tip at the generated taught position. When a registration operation is performed by the user in a state where the robot 2 is maintained at the taught position in the virtual space, the offline teaching unit 221 stores the taught position in the taught position storage unit 222.

The offline teaching unit 221 may automatically generate a plurality of taught positions representing the motion path from a start point (a taught position representing the start position of the motion path) to an end point (a taught position representing the end position of the motion path) when the start point and the end point of the motion path are specified. The simulation includes operating the robot 2 in the virtual space. For example, the offline teaching unit 221 repeatedly executes the following process 1 and process 2 until it is confirmed that there is no interference (collision) between the robot 2 and the surrounding objects throughout the entire motion path.
Process 1) Add, between the start point and the end point, a taught position that can avoid interference between the robot 2 and the surrounding objects.
Process 2) Confirm by simulation whether interference between the robot 2 and the surrounding objects is avoided in the motion path including the added taught position.
   The offline teaching unit 221 stores the plurality of taught positions generated as described above in the taught position storage unit 222.

The taught position registration unit 223 stores the plurality of taught positions stored in the taught position storage unit 222 in the taught position storage unit 123 of the robot controller 100. The taught position registration unit 223 may store, in the taught position storage unit 123, each of the plurality of taught positions stored in the taught position storage unit 222 in association with the reflection information indicating that reflection of the factor information is enabled. Although the factor information is not reflected in the taught positions generated by the offline teaching unit 221, the factor information is reflected by the robot control unit 113. Accordingly, the operation of the robot 2 in the real space with the error factor is brought closer to the taught position in the virtual space without the error factor, so the taught positions generated by the offline teaching unit 221 can be directly used for controlling the robot 2 in the real space. Therefore, the effort for motion teaching in the real space can be significantly reduced.

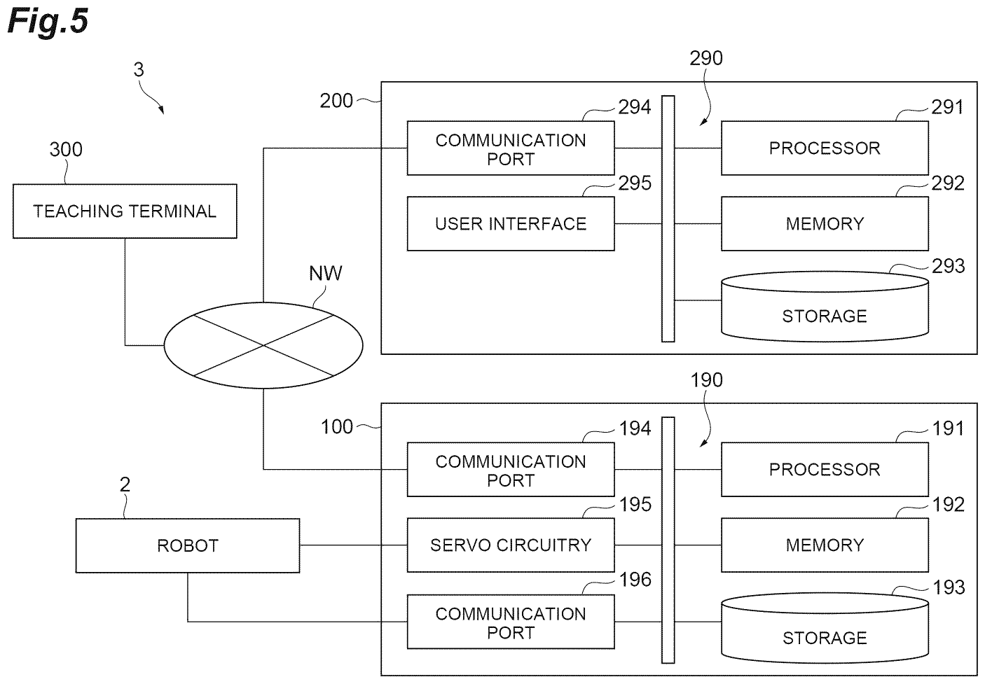

FIG. 5 is a block diagram illustrating an example hardware configuration of the control system 3. As illustrated in FIG. 5, the robot controller 100 includes circuitry 190. The circuitry 190 includes a processor 191, a memory 192, a storage 193, a communication port 194, and servo circuitry 195.

The storage 193 stores a program for causing the robot controller 100 to execute: storing factor information representing an error factor of operation caused by the structure of the arm 10; and controlling the robot 2 so that the motion error caused by the error factor is reduced based on the taught position representing the operation of the robot 2 and the factor information. For example, the storage 193 stores a program for configuring each functional block described above in the robot controller 100. The storage 193 is composed of one or more non-volatile storage devices. Examples of storage devices include hard disk drives and flash memories.

The memory 192 temporarily stores the program loaded from the storage 193. The memory 192 is composed of one or more volatile memory devices. Examples of memory devices include random access memory (RAM).

The processor 191 executes the program loaded into the memory 192 to configure each functional block described above in the robot controller 100. The data generated by the processor 191 is temporarily stored in the memory 192. The processor 191 is composed of one or more processing devices. Examples of processing devices include central processing units (CPUs) and graphics processing units (GPUs).

The communication port 194 communicates with the simulation device 200 and the teaching terminal 300 via the network NW in response to a request from the processor 191. The communication port 194 is composed of one or more network adapters. Examples of network adapters include Ethernet adapters.

The servo circuitry 195 supplies drive power to the motors 41, 42, 43, 44, 45, and 46 in response to a request from the processor 191. The servo circuitry 195 includes one or more power conversion circuits.

The communication port 196 communicates with the robot 2 in response to a request from the processor 191. Examples of the communication port 196 include industrial Ethernet adapters and fieldbus adapters.

The simulation device 200 includes circuitry 290. The circuitry 290 includes a processor 291, a memory 292, a storage 293, a communication port 294, and a user interface 295. The storage 293 stores a program for configuring each functional block described above in the simulation device 200. The storage 293 is composed of one or more non- volatile storage devices. Examples of storage devices include hard disk drives and flash memories.

The memory 292 temporarily stores the program loaded from the storage 293. The memory 292 is composed of one or more volatile memory devices. Examples of memory devices include random access memory (RAM).

The processor 291 executes the program loaded into the memory 292 to configure each functional block described above in the simulation device 200. The data generated by the processor 291 is temporarily stored in the memory 292. The processor 291 is composed of one or more processing devices. Examples of processing devices include central processing units (CPUs) and graphics processing units (GPUs).

The communication port 294 communicates with the robot controller 100 and the teaching terminal 300 via the network NW in response to a request from the processor 291. The communication port 294 is composed of one or more network adapters. Examples of network adapters include Ethernet adapters.

The user interface 295 acquires input from a user who is a human and outputs (for example, displays) information to the user in response to a request from the processor 291. The user interface 295 includes one or more input devices and one or more output devices. Examples of input devices include keyboards, mice, touchpads, and keypads. Examples of output devices include liquid crystal monitors and organic EL (Electro-Luminescence) monitors. The input device may be integrated with the output device as a so-called touch panel.

The configurations of the robot controller 100 and the simulation device 200 described above are merely examples. At least a part of the simulation device 200 may be incorporated into the robot controller 100. Not all functions of the robot controller 100 and the simulation device 200 may be executed by the execution of programs, and at least some of the functions may be configured by dedicated logic circuits such as ASICs (Application-Specific Integrated Circuits).

### Manufacturing Procedure of the Robot System

Next, as an example of the manufacturing method, an example procedure for manufacturing the control system 3 by preparing the robot 2 and the robot controller 100 will be illustrated. This procedure includes: operating, by the robot controller 100, the robot 2 in accordance with a predetermined motion command; generating factor information representing an error factor based on the motion command and the motion result of the robot 2; and storing the factor information in the storage unit of the control system 3. This procedure is executed in a factory or the like different from the actual usage environment of the robot 2.

Storing the factor information in the storage unit of the control system 3 may include storing the factor information in the factor storage unit 112 of the robot controller 100, and storing the factor information may include storing the factor information in the factor information storage unit 51 of the robot 2.

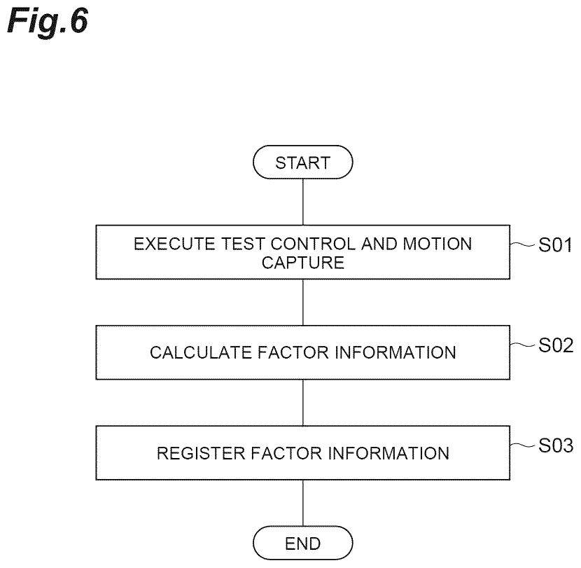

For example, as illustrated in FIG. 6, the manufacturing procedure includes operations S01, S02, and S03. In operation S01, the robot controller 100 operates the robot 2 in a predetermined motion pattern while holding a weight having a known weight on the end effector 19 and captures the operation of the robot 2 with an image sensor or a three-dimensional sensor. The robot controller 100 may operate the robot 2 multiple times in the same motion pattern while changing the weight of the weight.

In operation S02, the factor information representing the error factor is generated based on the motion pattern and the captured motion result of the robot 2. For example, in operation S02, the deflection of the arm 10 and the dimensional error unrelated to the deflection are detected based on the difference between the motion pattern and the motion result, the compliance of the arm 10 is detected based on the deflection and the weight of the weight, and the factor information including the dimensional error and the compliance is generated.

In operation S03, the factor information is written into the factor information storage unit 51 or the factor storage unit 112. In operation S03, the factor information may be written into both the factor information storage unit 51 and the factor storage unit 112. This completes the manufacturing procedure of the control system 3.

### Control Procedure

As an example of the control method, an example control procedure executed by the robot controller 100 will be illustrated. The control procedure includes: storing factor information representing an error factor of operation caused by the structure of the arm 10; and controlling the robot 2 so that the motion error caused by the error factor is reduced based on the taught position representing the operation of the robot 2 and the factor information. The control procedure may include a factor information acquisition procedure, an online teaching procedure, a playback control procedure, and a surrounding information acquisition procedure. Each procedure will be illustrated below.

### Factor Information Acquisition Procedure

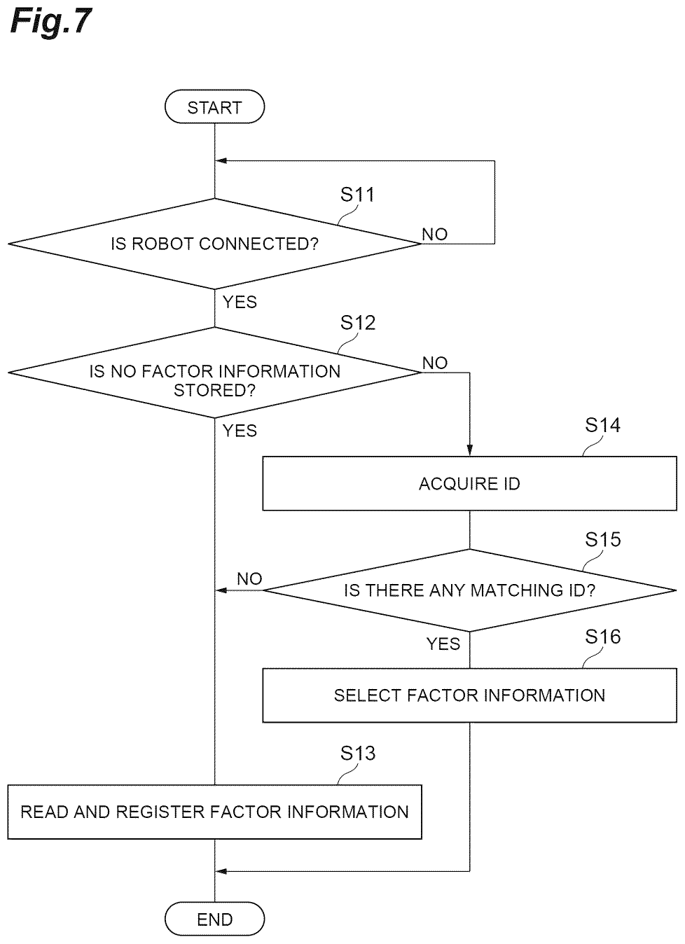

This procedure is executed by the robot controller 100 when the robot 2 includes the factor information storage unit 51. As illustrated in FIG. 7, the robot controller 100 first executes operations S11 and S12. In operation S11, the factor information registration unit 131 waits for the robot controller 100 to be connected to the robot 2. In operation S12, the factor information registration unit 131 checks whether the factor information is stored in the collation unit 132.

If it is determined in operation S12 that the factor information is not stored in the collation unit 132, the robot controller 100 executes operation S13. In operation S13, the factor information registration unit 131 reads the factor information from the factor information storage unit 51 and stores it in the factor storage unit 112.

If it is determined in operation S12 that the factor information is stored in the collation unit 132, the robot controller 100 executes operations S14 and S15. In operation S14, the collation unit 132 acquires the ID of the robot 2 from the ID storage unit 52. In operation S15, the collation unit 132 checks whether the factor information corresponding to the ID of the robot 2 is stored in the factor storage unit 112.

If it is determined in operation S15 that the factor information corresponding to the ID of the robot 2 is not stored in the factor storage unit 112, the robot controller 100 executes the above operation S13. If it is determined in operation S15 that the factor information corresponding to the ID of the robot 2 is stored in the factor storage unit 112, the robot controller 100 executes operation S16. In operation S16, the command generation unit 114 selects the factor information corresponding to the ID of the robot 2 from the factor storage unit 112. This completes the factor information acquisition procedure.

### Online Teaching Procedure

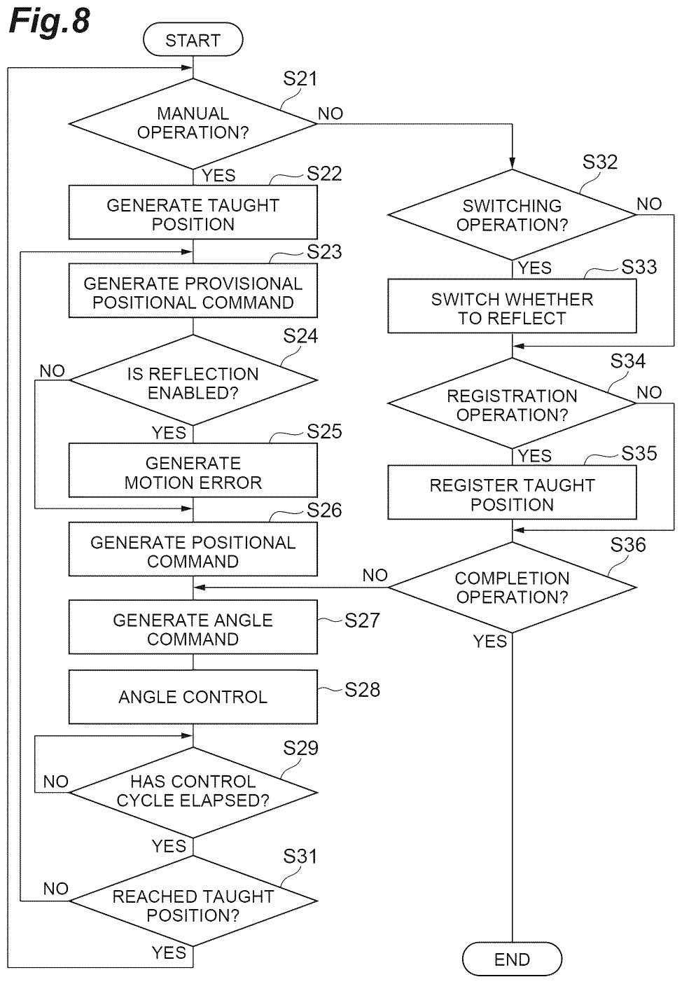

This procedure registers the taught position while operating the robot 2 by manual operation by the user. As illustrated in FIG. 8, the robot controller 100 first executes operation S21. In operation S21, the manual control unit 121 checks whether manual operation is being performed by the user on the teaching terminal 300.

If it is determined in operation S21 that manual operation is being performed, the robot controller 100 executes operations S22, S23, and S24. In operation S22, the manual control unit 121 generates a taught position based on the manual operation by the user. In operation S23, the manual control unit 121 generates a provisional positional command based on the generated taught position. In operation S24, the manual control unit 121 checks whether reflection of the factor information is enabled. If it is determined in operation S24 that the reflection is enabled, the robot controller 100 executes operation S25. In operation S25, the manual control unit 121 calculates the motion error based on the provisional positional command and the factor information.

Next, the robot controller 100 executes operation S26. If it is determined in operation S24 that the reflection is disabled, the robot controller 100 skips operation S25 and directly executes operation S26. In operation S26, the manual control unit 121 generates a positional command based on the provisional positional command and the motion error. For example, the manual control unit 121 generates the positional command by adding a vector of the same magnitude as the motion error but in the opposite direction to the provisional positional command. If operation S25 is not executed, the manual control unit 121 uses the provisional positional command as the positional command.

Next, the robot controller 100 executes operations S27, S28, and S29. In operation S27, the motion control unit 115 calculates the target angle of each of the joints 31, 32, 33, 34, 35, and 36 corresponding to the positional command by inverse kinematic calculation based on the kinematic parameters.

Note that the above procedure illustrates an example in which the target angle of each of the joints 31, 32, 33, 34, 35, and 36 is calculated by inverse kinematic calculation after calculating the positional command based on the provisional positional command and the motion error, but it is not limited to this. The target angle of each of the joints 31, 32, 33, 34, 35, and 36 may be calculated by inverse kinematic calculation based on the provisional positional command, and then calculation of the motion error based on the target angles and correction of the target angles may be repeated so as to reduce the motion error. The target angle of each of the corrected joints 31, 32, 33, 34, 35, and 36 after the correction is the positional commands that indirectly represent the intermediate position and intermediate posture of the hand tip.

In operation S28, the motion control unit 115 controls the motors 41, 42, 43, 44, 45, and 46 to follow the target angles of the joints 31, 32, 33, 34, 35, and 36. In operation S29, the manual control unit 121 waits for the control cycle to elapse.

Next, the robot controller 100 executes operation S31. In operation S31, the manual control unit 121 checks whether the hand tip of the robot 2 has reached the taught position. If it is determined in operation S31 that the hand tip of the robot 2 has not reached the taught position, the robot controller 100 returns the process to operation S23. Thereafter, the generation of the positional command and the control of the motors 41, 42, 43, 44, 45, and 46 by the positional command are repeated at the control cycle until the hand tip of the robot 2 reaches the taught position.

If it is determined in operation S31 that the hand tip of the robot 2 has reached the taught position, the robot controller 100 returns the process to operation S21. If it is determined in operation S21 that manual operation is not being performed, the robot controller 100 executes operation S32. In operation S32, the switching unit 124 checks whether a switching operation is being performed by the user on the teaching terminal 300.

If it is determined in operation S32 that a switching operation is being performed, the robot controller 100 executes operation S33. In operation S33, the switching unit 124 switches the reflection of the factor information. For example, if the reflection was enabled before the switch, the switching unit 124 switches the reflection to disabled. If the reflection was disabled before the switch, the switching unit 124 switches the reflection to enabled.

Next, the robot controller 100 executes operation S34. If it is determined in operation S32 that a switching operation is not being performed, the robot controller 100 skips operation S33 and directly executes operation S34. In operation S34, the taught position registration unit 122 checks whether a registration operation is being performed by the user on the teaching terminal 300. If it is determined in operation S34 that the registration operation is being performed, the robot controller 100 executes operation S35. In operation S35, the taught position registration unit 122 stores the taught position and the reflection information indicating whether reflection of the factor information is enabled in the taught position storage unit 123 in association.

Next, the robot controller 100 executes operation S36. If it is

determined in operation S34 that the registration operation is not being performed, the robot controller 100 skips operation S35 and directly executes operation S36. In operation S36, the manual control unit 121 checks whether a completion operation is performed by the user on the teaching terminal 300. If it is determined in operation S36 that the completion operation is not performed, the robot controller 100 executes operation S27. As a result, even while waiting for manual operation, the control of the motors 41, 42, 43, 44, 45, and 46 by the generated positional command is repeated at the control cycle. If it is determined in operation S36 that the completion operation is performed, the robot controller 100 completes the online teaching procedure.

### Playback Control Procedure

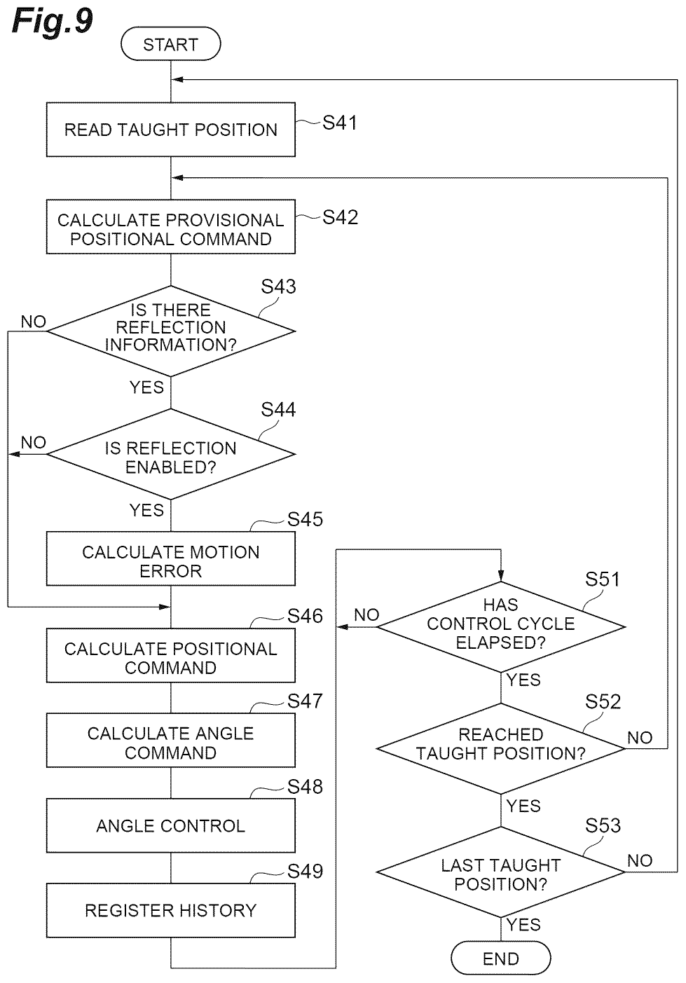

This procedure operates the robot 2 based on a plurality of taught positions registered in the taught position storage unit 123 by the above online teaching procedure or the like. As illustrated in FIG. 9, the robot controller 100 executes operations S41, S42, and S43. In operation S41, the command generation unit 114 reads the next taught position from the taught position storage unit 123. In operation S42, the command generation unit 114 calculates the provisional positional command based on the taught position. In operation S43, the command generation unit 114 checks whether the reflection information is associated with the taught position.

If it is determined in operation S43 that the reflection information is associated with the taught position, the robot controller 100 executes operation S44. In operation S44, the command generation unit 114 checks whether the reflection information indicates that reflection is enabled. If it is determined in operation S44 that the reflection information indicates that the reflection is enabled, the robot controller 100 executes operation S45. In operation S45, the parameter storage unit 111 calculates the motion error based on the provisional positional command and the factor information.

Next, the robot controller 100 executes operation S46. If it is determined in operation S43 that the reflection information is not associated with the taught position, or if it is determined in operation S44 that the reflection information indicates that the reflection is disabled, the robot controller 100 skips operation S45 and directly executes operation S46. In operation S46, the parameter storage unit 111 generates the positional command based on the provisional positional command and the motion error. For example, the command generation unit 114 generates the positional command by adding a vector of the same magnitude as the motion error but in the opposite direction to the provisional positional command. If operation S45 is not executed, the command generation unit 114 uses the provisional positional command as the positional command.

Next, the robot controller 100 executes operations S47, S48, and S49. In operation S47, the motion control unit 115 calculates the target angles of the joints 31, 32, 33, 34, 35, and 36 corresponding to the positional command by inverse kinematic calculation based on the kinematic parameters.

Note that the above procedure illustrates an example in which the target angle of each of the joints 31, 32, 33, 34, 35, and 36 is calculated by inverse kinematic calculation after calculating the positional command based on the provisional positional command and the motion error, but it is not limited to this. The target angle of each of the joints 31, 32, 33, 34, 35, and 36 may be calculated by inverse kinematic calculation based on the provisional positional command, and then the motion error may be calculated based on the target angles, and the target angles may be corrected to reduce the motion error. The target angle of each of the corrected joints 31, 32, 33, 34, 35, and 36 indirectly represents the intermediate position and intermediate posture of the hand tip as the positional command.

In operation S48, the motion control unit 115 controls the motors 41, 42, 43, 44, 45, and 46 so that the angle of each of the joints 31, 32, 33, 34, 35, and 36 follows its target angle. In operation S49, the motion control unit 115 stores the motion record in the history storage unit 116 in association with the time and at least one of the positional command and the provisional positional command.

Next, the robot controller 100 executes operations S51 and S52. In operation S51, the command generation unit 114 waits for the control cycle to elapse. In operation S52, the command generation unit 114 checks whether the hand tip of the robot 2 has reached the taught position. If it is determined in operation S52 that the hand tip of the robot 2 has not reached the taught position, the robot controller 100 returns the process to operation S42. Thereafter, the generation of the positional command and the control of the motors 41, 42, 43, 44, 45, and 46 by the positional command are repeated at the control cycle until the hand tip of the robot 2 reaches the taught position.

If it is determined in operation S52 that the hand tip of the robot 2 has reached the taught position, the robot controller 100 executes operation S53. In operation S53, the command generation unit 114 checks whether the reached taught position is the last (the last in the time series) taught position.

If it is determined in operation S53 that the taught position is not the last taught position, the robot controller 100 returns the process to operation S41. Thereafter, the reading of the taught position and the movement of the hand tip of the robot 2 to the read taught position are repeated until the robot 2 reaches the last taught position.

If it is determined in operation S53 that the taught position is the last taught position, the robot controller 100 completes the control of the robot 2.

### Surrounding Information Acquisition Procedure

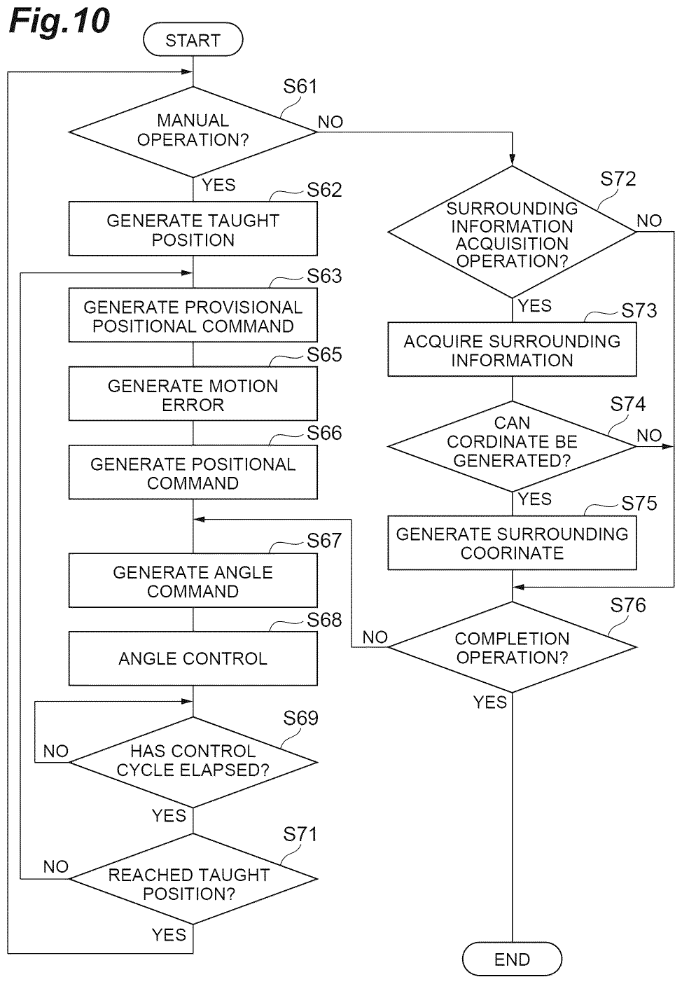

This procedure acquires the positional information of the surrounding object based on the taught position while operating the robot 2 by manual operation by the user. The procedure illustrated in FIG. 10 includes operations S61 to S63, which are similar to operations S21 to S23 that operates the robot 2 by manual operation in the above online teaching procedure, and operations S65 to S71, which are similar to operations S25 to S31. If it is determined in operation S61 that manual operation is not being performed, the robot controller 100 executes operation S72. In operation S72, the surrounding information acquisition unit 125 checks whether a surrounding information acquisition operation is performed by the user on the teaching terminal 300.

If it is determined in operation S72 that a surrounding information acquisition operation is performed, the robot controller 100 executes operations S73 and S74. In operation S73, the surrounding information acquisition unit 125 acquires the positional information of the surrounding object based on the relative position of the hand tip with respect to the surrounding object and the taught position at which the hand tip reaches the relative position. In operation S74, the surrounding information acquisition unit 125 checks whether the positional information of a plurality of predetermined positions for acquiring the relationship between the surrounding coordinate system and the robot coordinate system has been collected.

If it is determined in operation S74 that the positional information of a plurality of predetermined positions has been collected, the robot controller 100 executes operation S75. In operation S75, the surrounding information acquisition unit 125 acquires the relationship between the surrounding coordinate system and the robot coordinate system based on the positional information of the plurality of predetermined positions.

Next, the robot controller 100 executes operation S76. If it is determined in operation S74 that the positional information of a plurality of predetermined positions has not been collected, the robot controller 100 skips operation S75 and directly executes operation S76. If it is determined in operation S72 that a surrounding information acquisition operation is not performed, the robot controller 100 skips operations S73, S74, and S75 and directly executes operation S76. In operation S76, the manual control unit 121 checks whether a completion operation is performed by the user on the teaching terminal 300.

If it is determined in operation S76 that a completion operation is not performed, the robot controller 100 executes operation S67. As a result, even while waiting for manual operation, the control of the motors 41, 42, 43, 44, 45, and 46 by the generated positional command is repeated at the control cycle. If it is determined in operation S76 that a completion operation is performed, the robot controller 100 completes the online teaching procedure.

### Simulation Procedure

Next, as an example of the simulation method, an example simulation procedure executed by the simulation device 200 will be illustrated. This procedure may include an operation reproduction procedure and an offline teaching procedure. Each procedure will be illustrated below.

### Operation Reproduction Procedure

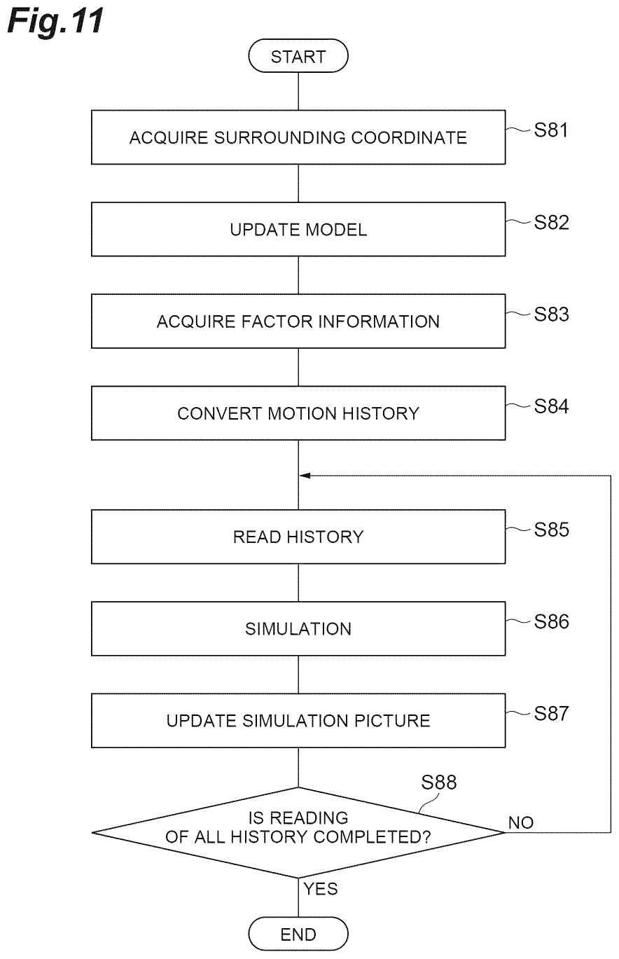

This procedure reproduces, in the virtual space, the operation of the robot 2 in the real space based on the motion history of the robot 2 stored in the history storage unit 116. As illustrated in FIG. 11, the simulation device 200 executes operations S81, S82, S83, and S84. In operation S81, the model calibrator 217 acquires the positional information of the surrounding object from the surrounding information acquisition unit 125. In operation S82, the model calibrator 217 corrects the position of the model of the surrounding object stored in the model storage unit 211 based on the positional information of the surrounding object. In operation S83, the factor replication unit 212 acquires the factor information from the factor storage unit 112 of the robot 2 and stores it in the second factor storage unit 213. In operation S84, the history conversion unit 214 converts the motion history stored in the history storage unit 116 into the motion history when the motion error is not reduced based on the factor information stored in the second factor storage unit 213 and stores it in the second history storage unit 215.

Next, the simulation device 200 executes operations S85, S86, S87, and S88. In operation S85, the simulator 216 reads the next motion record from the motion history stored in the second history storage unit 215. In operation S86, the simulator 216 reproduces the posture of the robot 2 in the virtual space based on the model of the robot 2 stored in the model storage unit 211 and the motion record read by the simulator 216. In operation S87, the simulator 216 updates the simulation image representing the virtual space based on the posture of the robot 2. The simulation image is displayed on the user interface 295 or the like. In operation S88, the simulator 216 checks whether all the motion history stored in the second history storage unit 215 has been read. If it is determined in operation S88 that the reading of the motion history is not completed, the simulation device 200 returns the process to operation S85. Thereafter, the reading of the next motion record and the updating of the simulation image based on the read motion record are repeated until the reading of the motion history is completed. If it is determined in operation S88 that the reading of the motion history is completed, the simulation device 200 completes the operation reproduction procedure.

Note that the above illustrates a procedure in which the entire motion history is converted in operation S84, and then operations S85 to S88 are repeated based on the converted motion history, but it is not limited to this. Instead of converting the entire motion history in operation S84, the motion record read in operation S85 may be converted into the motion record when the motion error is not reduced every time the motion record is read, and operations S86 to S88 may be executed based on the converted motion record.

### Offline Teaching Procedure

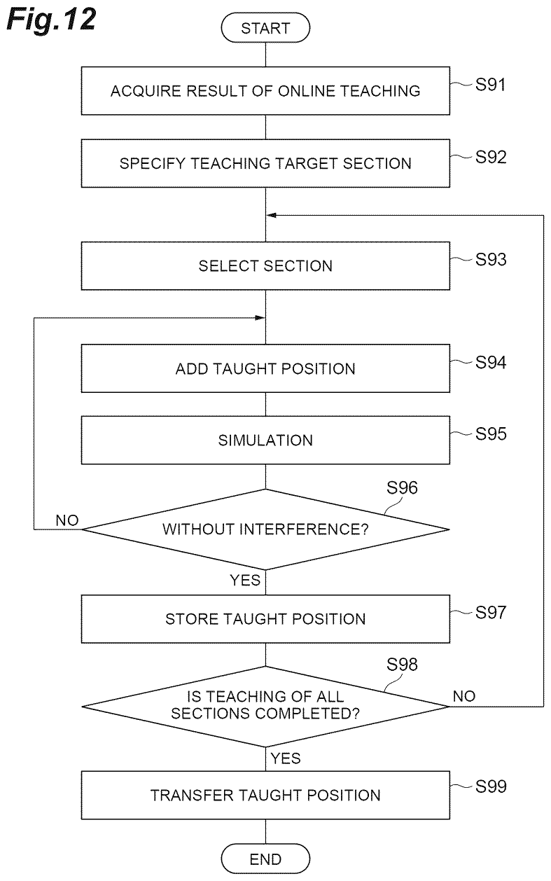

This procedure automatically generates taught positions by simulation. As illustrated in FIG. 12, the simulation device 200 executes operations S91, S92, and S93. In operation S91, the offline teaching unit 221 acquires partial online teaching results stored in the taught position storage unit 123. The partial online teaching results include a predetermined section in which the motion path is defined by a plurality of taught positions and an undefined section in which the motion path is not defined. In operation S92, the offline teaching unit 221 specifies one or more undefined sections as teaching target sections. In operation S93, the offline teaching unit 221 selects one or more of the undefined sections. As a result, the start point and the end point are determined.

Next, the simulation device 200 executes operations S94, S95, and S96. In operation S94, the offline teaching unit 221 adds a taught position that can avoid interference between the robot 2 and the surrounding objects between the start point and the end point. In operation S95, the robot 2 is operated in the virtual space in the motion path including the added taught position. In operation S96, whether there is interference between the robot 2 and the surrounding objects during the operation in the virtual space is checked. If it is determined in operation S96 that there is interference, the simulation device 200 returns the process to operation S94. Thereafter, the addition of the taught position and the simulation are repeated until it is determined that there is no interference. As a result, the motion path is defined for the undefined section.

If it is determined in operation S96 that there is no interference, the simulation device 200 executes operations S97 and S98. In operation S97, the offline teaching unit 221 stores the plurality of taught positions for the selected undefined section in the taught position storage unit 222. In operation S98, whether the motion path has been defined for all of the one or more undefined sections is checked.

If it is determined in operation S98 that there are still undefined sections remaining, the simulation device 200 returns the process to operation S93. If it is determined in operation S98 that the motion path has been defined for all of the one or more undefined sections, the simulation device 200 executes operation S99. In operation S99, the taught position registration unit 223 stores the plurality of taught positions generated by the offline teaching unit 221 for each of the one or more undefined sections in the taught position storage unit 123. This completes the offline teaching procedure.

The above disclosure include the following configurations: (1) A robot system 1 comprising: a robot 2 having an arm 10 capable of changing a position of a hand tip; and a robot controller 100 configured to control the robot 2, wherein the robot controller 100 comprises: a factor storage unit 112 configured to store factor information representing an error factor of a motion caused by a structure of the arm 10; and a robot control unit 113 configured to control the robot 2 so that a motion error caused by the error factor is reduced based on a taught position representing the motion of the robot 2 and the factor information. The motion error caused by the error factor is reduced when controlling the robot 2 based on the taught position without including the error factor in the taught position. Therefore, even if the taught position is generated without considering the error factor, control that reduces the motion error with respect to the taught position is executed. Accordingly, a system beneficial in improving the workability of motion teaching can be provided. According to the system, the robot 2 can be controlled with accuracy in the real space even by the taught position generated by offline teaching in a virtual space without an error factor. Moreover, the teaching result can be applied to a plurality of robots 2 with individual differences.

(2) The robot system 1 according to (1), wherein the robot control unit 113 comprises: a command generation unit 114 configured to sequentially generate positional commands representing intermediate positions of the robot 2 to the taught position based on the taught position and the factor information; and a motion control unit 115 configured to control the robot 2 by the positional commands that are sequentially generated.

The motion error can be reduced even in the intermediate path to the taught position.

(3) The robot system 1 according to (2), wherein the error factor includes compliance of the arm 10, and the command generation unit 114 is configured to: generate a provisional positional command based on the taught position; calculate the deflection of the arm 10 based on the provisional positional command and the compliance; and generate the positional command based on the deflection and the provisional positional command. The motion error due to the deflection can be reduced with accuracy.

(4) The robot system 1 according to (3), wherein the error factor further includes a dimensional error of the arm 10, and wherein the command generation unit 114 is configured to: calculate the deflection of the arm 10 based on the provisional positional command and the compliance; and generate the positional command based on the provisional positional command, the dimensional error, and the deflection. By considering both the dimensional error and the deflection, the motion error can be further reduced. The dimensional error may be used when calculating the deflection. The component of the dimensional error in the deflection can be included in the calculation for each posture of the robot 2, thereby improving accuracy. The dimensional error can be reflected in the original parameters of the robot 2 (dimensions of the robot 2 used in motion calculations), or it can be stored separately as an error amount and reflected in each calculation. This allows the ideal dimensions and the actual errors to be handled separately.

(5) The robot system 1 according to any one of (2) to (4), further comprising: a history conversion unit 214 configured to convert, based on the factor information, a motion history of the robot 2 into the motion history in a case where the motion error is not reduced; and a simulator 216 configured to reproduce the motion of the robot 2 in a virtual space based on the model of the robot 2 that does not include the error factor and the converted motion history.

The operation of the robot 2 in the real space with the error factor can be readily reproduced in the virtual space without the error factor. Therefore, the influence of the error factor in the simulation can be removed, and the actual operation can be reproduced. Although the simulation may be performed using the unconverted motion history in a virtual space with the error factor, the simulation may be reconstructed for each error factor of each robot, and the calculation amount becomes enormous, making it very difficult to reproduce the actual operation. In the robot system 1, assuming that the reality includes the error factor and the simulation does not include the error factor, the error factor is corrected when operating the robot 2, and the error factor is restored when reproducing in the simulation. Therefore, the way the error factor is reflected is intuitively understandable for the user, and the system construction and operation can be facilitated.

(6) The robot system 1 according to (5), further comprising a factor replication unit 212 configured to acquire the factor information from the factor storage unit 112 of the robot controller 100 and store the factor information in a second factor storage unit 213 outside the robot controller 100, wherein the history conversion unit 214 is configured to convert the motion history into the motion history in a case where the motion error is not reduced based on the factor information stored in the second factor storage unit 213.

By storing the factor information in the second factor storage unit 213 separate from the factor storage unit 112 of the robot controller 100, the conversion of the motion history and the reproduction of the operation of the robot 2 in the virtual space can be executed even when the robot controller 100 is not activated.

(7) The robot system 1 according to (3) or (4), further comprising: a history storage unit 116 configured to store the motion history of the robot 2 in association with at least one of the positional command and the provisional positional command; a history conversion unit 214 configured to convert, based on the factor information, the motion history of the robot 2 into the motion history in a case where the motion error is not reduced, and a simulator 216 configured to reproduce the motion of the robot 2 in a virtual space based on the model of the robot 2 without the error factor and the converted motion history.

By comparing the motion history with the positional command or the provisional positional command, the presence of external factors such as collisions can be readily verified afterward.

(8) The robot system 1 according to any one of (1) to (7), further comprising: a manual control unit 121 configured to generate the taught position based on manual operation by a user and control the robot 2 so that the motion error is reduced based on the generated taught position and the factor information; and a taught position registration unit 122 configured to store the taught position based on the manual operation in the taught position storage unit 123 in response to a registration request by the user, wherein the robot control unit 113 is configured to control the robot 2 so that the motion error is reduced based on the taught position stored in the taught position storage unit 123 and the factor information. The taught position can be registered by visually confirming that the motion error is reduced based on the factor information compared to the taught position based on manual operation. Since the taught position is registered with the value before reflecting the error factor, the error factor can be excluded from the taught position. Therefore, the taught position without considering the error factor can be readily registered in the actual machine with the error factor.

(9) The robot system 1 according to (8), further comprising a switching unit 124 configured to switch whether the reflection of the factor information by the manual control unit 121 is enabled, wherein the manual control unit 121 is configured to: control the robot 2 based on the taught position based on the manual operation and the factor information when the reflection of the factor information is enabled; and control the robot 2 not based on the factor information but based on the taught position based on the manual operation when the reflection of the factor information is disabled, wherein the taught position registration unit 122 is configured to store reflection information indicating whether the factor information is reflected in the taught position storage unit 123 in association with the taught position based on the manual operation, and wherein the robot control unit 113 is configured to: control the robot 2 based on the taught position and the factor information when the reflection information corresponding to the taught position indicates that reflection of the factor information is enabled, and controls the robot 2 not based on the factor information but based on the taught position when the reflection information corresponding to the taught position indicates that reflection of the factor information is disabled.

By matching the presence or absence of the reduction of the motion error at the time of registering the taught position and at the time of playing back the registered taught position, unexpected operation of the robot 2 can be prevented.

(10) The robot system 1 according to any one of (1) to (9), further comprising a taught position storage unit 123 configured to store the taught position in association with the reflection information indicating whether reflection of the factor information by the robot control unit 113 is enabled, wherein the robot control unit 113 is configured to: control the robot 2 based on the taught position and the factor information when the reflection information corresponding to the taught position indicates that reflection of the factor information is enabled; and control the robot 2 not based on the factor information but based on the taught position when the reflection information corresponding to the taught position indicates that reflection of the factor information is disabled.

By switching whether to reduce the motion error based on the reflection information associated with the taught position in advance, unexpected operation of the robot 2 due to the mismatch between the taught position and whether to reduce the motion error can be prevented.

(11) The robot system 1 according to (10), wherein the robot control unit 113 is configured to control the robot 2 not based on the factor information but based on the taught position when the reflection information is not associated with the taught position stored in the taught position storage unit 123.

Unexpected operation of the robot 2 due to the application of the motion error reduction function to a taught position that does not assume the motion error reduction function can be prevented.

(12) The robot system 1 according to any one of (1) to (11), further comprising a surrounding information acquisition unit 125 configured to acquire positional information of a surrounding object based on the relative position of the hand tip with respect to the surrounding object and the taught position that causes the hand tip to reach the relative position. Due to the reduction of the motion error, the difference between the position of the hand tip and the taught position is minimized. Accordingly, the positional information of the surrounding object can be readily acquired with accuracy based on the taught position.

(13) The robot system 1 according to (12), further comprising: a model calibrator 217 configured to correct a position of a model of the surrounding object in a virtual space based on acquired positional information of the surrounding object; and a simulator 216 configured to operate the robot 2 in the virtual space.

The virtual space in which the positional information of the surrounding object acquired with accuracy is reflected in the model allows the relationship between the operation of the robot 2 and the surrounding object to be simulated with accuracy.

(14) The robot system 1 according to (13), further comprising an offline teaching unit 221 configured to generate the taught position based on the motion of the robot 2 in the virtual space.

Since the motion error reduction is performed by the robot controller 100, a taught position that can be readily applied to the real space can be generated based on the operation of the robot 2 in the virtual space without the error factor of the robot 2 and with the corrected position of the surrounding object.

(15) The robot system 1 according to any one of (1) to (14), wherein the factor storage unit 112 is configured to store a plurality of pieces of factor information corresponding to a plurality of robots 2, wherein the robot control unit 113 is configured to select one of the plurality of pieces of factor information in accordance with the robot 2 to be controlled and controls the robot 2 based on the selected factor information.

A plurality of robots 2 with individual differences can be controlled with accuracy using the same taught position.

(16) The robot system 1 according to any one of (1) to (15), wherein the factor storage unit 112 is configured to store an ID of the robot 2 corresponding to the factor information, and wherein the robot control unit 113 is configured to control the robot 2 based on the factor information when the ID of the robot 2 to be controlled matches the ID corresponding to the factor information.

The mismatch between the factor information and the robot 2 can be readily prevented.

(17) The robot system 1 according to any one of (1) to (16), wherein the robot 2 further comprises a factor information storage unit 51 configured to store the factor information, and wherein the robot controller further comprises a factor information registration unit 131 configured to acquire the factor information from the factor information storage unit 51 of the robot 2 and store the factor information in the factor storage unit 112.

The mismatch between the factor information and the robot 2 can be readily prevented.

(18) The robot system 1 according to (17), wherein the robot controller 100 further comprises a collation unit 132 configured to collate the factor information stored in the robot 2 with the factor information stored in the factor storage unit 112.

The mismatch between the factor information and the robot 2 can be further prevented.

(19) A method for manufacturing a robot system 1 comprising a robot 2 having an arm 10 capable of changing a position of a hand tip and a robot controller 100 configured to control the robot 2, the method comprising: operating the robot 2 in a predetermined motion pattern by the robot controller 100; generating factor information representing an error factor of motion caused by the structure of the arm 10 based on the motion pattern and a motion result of the robot 2; and storing the factor information in a storage unit of the robot system 1.

The factor information is generated in a unified environment within the production line using a dedicated device, and the generated factor information is preset in the robot system 1. Therefore, a reliable and user-friendly robot system 1 can be manufactured.

(20) The method for manufacturing the robot system 1 according to (19), wherein storing the factor information in the storage unit of the robot system 1 includes storing the factor information in the storage unit of the robot 2.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A robot system comprising:
a robot having an arm configured to change a position of an extremity of the arm;
factor storage that stores factor information representing an error factor of a motion of the robot, wherein the error factor is a mechanical characteristic of the robot that causes a positional error of the extremity; and
control circuitry configured to control, based on a taught position and the factor information, the robot to move the extremity toward the taught position with a positional adjustment of the robot to reduce the positional error.

2. The robot system according to claim 1, wherein the control circuitry is further configured to:
sequentially generate positional commands representing intermediate positions of the robot to the taught position based on the taught position and the factor information so that the extremity moves toward the taught position with the positional adjustment; and
control the robot according to the positional commands that are sequentially generated.

3. The robot system according to claim 2, wherein the error factor includes compliance of the arm, and
wherein the control circuitry is configured to repeat operations including:
generating a provisional positional command based on the taught position;
calculating, as the positional error, a deflection of the arm based on the provisional positional command and the compliance;
generating the positional command based on the deflection and the provisional positional command; and
control the robot according to the positional command.

4. The robot system according to claim 3, wherein the error factor further includes a dimensional error of the arm, and
wherein the control circuitry is configured to generate the positional command based on the provisional positional command, the dimensional error, and the deflection in the operation.

5. The robot system according to claim 2, further comprising simulation circuitry configured to:
convert a motion history of the robot by removing, based on the factor information, a history of the positional adjustment from the motion history; and
simulate the motion of the robot in a virtual space based on a model of the robot that does not include the error factor and the converted motion history.

6. The robot system according to claim 5, wherein the simulation circuitry is further configured to:
acquire the factor information from a factor storage of the control circuitry and store the factor information in a second factor storage; and
convert the motion history based on the factor information stored in the second factor storage.

7. The robot system according to claim 3, further comprising simulation circuitry configured to:
store a motion history of the robot in association with one or both of the positional command and the provisional positional command;
convert the motion history of the robot by removing, based on the factor information, a history of the positional adjustment from the motion history; and
simulate the motion of the robot in a virtual space based on a model of the robot that does not include the error factor and the converted motion history.

8. The robot system according to claim 1, wherein the control circuitry is further configured to:
generate a manually taught position based on manual operation by a user;
calculate, based on the manually taught position and the factor information, a second positional error of the extremity that would occur during an expected motion toward the manually taught position;
control, based on the manually taught position and the second positional error, the robot to move the extremity toward the manually taught position with the positional adjustment to reduce the second positional error;
store the manually taught position as the taught position in a taught position storage in response to a registration request by the user;
calculate the positional error based on the stored taught position and the factor information; and
control, based on the stored taught position and the positional error, the robot to move the extremity toward the stored taught position with the positional adjustment.

9. The robot system according to claim 8, wherein the control circuitry is further configured to:
switch, in response to a switch request by the user, whether an error reduction is enabled;
control, based on the manually taught position and the second positional error, the robot to move the extremity toward the manually taught position with the positional adjustment in response to determining that the error reduction is enabled;
control, based on the manually taught position, the robot to move the extremity toward the manually taught position without the positional adjustment in response to determining that the error reduction is disabled;
store setting information indicating whether the error reduction is enabled in the taught position storage in association with the manually taught position;
control, based on the stored taught position and the positional error, the robot to move the extremity toward the stored taught position with the positional adjustment in response to determining that the setting information corresponding to the stored taught position indicates that the error reduction is enabled; and
control, based on the stored taught position, the robot to move the extremity toward the stored taught position without the positional adjustment in response to determining that the setting information corresponding to the stored taught position indicates that the error reduction is disabled.

10. The robot system according to claim 1, wherein the control circuitry is further configured to:
store, in a taught position storage, the taught position in association with setting information indicating whether an error reduction is enabled;
control, based on the taught position and the positional error, the robot to move the extremity toward the stored taught position with the positional adjustment in response to determining that the setting information corresponding to the stored taught position indicates that the error reduction is enabled; and
control, based on the stored taught position, the robot to move the extremity toward the stored taught position without the positional adjustment in response to determining that the setting information corresponding to the taught position indicates that the error reduction is disabled.

11. The robot system according to claim 10, wherein the control circuitry is configured to control, based on the stored taught position, the robot to move the extremity toward the stored taught position without the positional adjustment in response to determining that the setting information is not associated with the stored taught position.

12. The robot system according to claim 1, wherein the control circuitry is further configured to acquire positional information of a surrounding object of the robot based on a relative position of the extremity with respect to the surrounding object and the taught position that causes the extremity to reach the relative position.

13. The robot system according to claim 12, further comprising simulation circuitry configured to:
correct a position of a model of the surrounding object in a virtual space based on acquired positional information of the surrounding object; and
operate the robot in the virtual space.

14. The robot system according to claim 13, wherein the simulation circuitry is further configured to generate the taught position based on the motion of the robot in the virtual space.

15. The robot system according to claim 1, wherein the factor information is stored for each of a plurality of robots including the robot, and
wherein the control circuitry is configured to:
select the factor information corresponding to the robot to be controlled; and
control the robot based on the selected factor information.

16. The robot system according to claim 1, wherein the factor information is stored in the factor storage in association with an ID of the robot;
acquire an ID from the robot to be controlled; and
control the robot based on the factor information in response to the acquired ID matches the ID associated with the factor information in the factor storage.

17. The robot system according to claim 1, wherein the factor information is stored in the robot, and
wherein the control circuitry is further configured to acquire the factor information from the robot and store the factor information.

18. The robot system according to claim 17, wherein the control circuitry is further configured to collate the factor information stored in the robot with the factor information stored in the factor storage.

19. A method for manufacturing a robot system comprising a robot having an arm configured to change a position of an extremity of the arm and a control circuitry configured to control the robot, the method comprising:
operating, by the control circuitry, the robot according to a predetermined motion pattern by the control circuitry;
generating factor information representing an error factor based on the motion pattern and an actual motion of the robot according to the motion pattern, wherein the error factor is mechanical characteristic of the robot that causes a positional error of the extremity; and
storing the factor information in the robot system.

20. The method according to claim 19, wherein storing the factor information in the robot system comprises storing the factor information in the robot.
